(19) United States
(12) Patent Application Publication
(10) Pub. No.: US 2006/0062993 A1
(43) Pub. Date: Mar. 23, 2006

(54) Laminated member for automobile interior ceiling material

(75) Inventors: Mitsutoshi Ogata, Tokyo (JP); Rick Sereno, North Manchester, IN (US); John Fredrick, Auburn Hills, MI (US); Toshio Suzuki, North Manchester, IN (US); Kunio Cho, Nottingham (GB); Ilhyun Kim, Nottingham (GB)

Correspondence Address: GREENBLUM & BERNSTEIN, P.L.C., 1950 ROLAND CLARKE PLACE, RESTON, VA, 20191, US

(73) Assignee: OJI Interpack Co., Ltd., Tokyo (JP)

(21) Appl. No.: 11/075,860

(22) Filed: Mar. 10, 2005

(30) Foreign Application Priority Data
Sep. 17, 2004 (JP) 2004-270809

(51) Int. Cl. B32B 27/00

(52) U.S. Cl. 428/319.3; 428/319.7; 428/319.9

(57) ABSTRACT

Provided is a laminated member for a novel automobile interior ceiling material which has good film formability, lightweight and high rigidity, excellent moldability on cold-pressing after preheating, no problem of wrinkles, improved shrinkage and heat resistance of a post-molding product (automobile interior ceiling material), and a small post-molding dimensional error. A laminated member (A) has a seven-layered structure including filler-containing polypropylene sheets (4 and 5) laminated on both sides of a foamed polyurethane sheet (1) with hot melt materials (adhesive layers) (2 and 3) interposed therebetween, and an adhesive layer (6) laminated to adhere an interior material (8) to an outer surface of one-sided filler-containing polypropylene sheet (4) and a backing material (7) adhered to an outer surface of the other-sided filler-containing polypropylene sheet (5).

### BACKGROUND OF THE INVENTION

1. Field of the Invention

The present invention relates to a laminated member of a multi-layered structure serving as a base material for forming an interior ceiling inside an automobile, and an automobile interior ceiling material formed of the laminated member.

2. Description of the Related Art

Conventionally, as a ceiling material attached to an indoor surface of an automobile top plate for constructing an interior ceiling, a member based on a glass fiber, such as one of kneading the glass fiber to a polyethylene or polypropylene sheet, one of mixing the glass fiber into either a polypropylene fiber or a natural fiber such as a flax and laminating the mixture by means of a needle punching process, one of bonding a sheet of the glass fiber on both surfaces of a polyurethane foam or so forth, has been predominantly used.

However, the member employing this glass fiber is excellent in dimensional stability, rigidity or heat resistance, but it involves the problems of molding workability, environmental aspect, recycle capability and so forth.

For that reason, as a future tendency, it is required to develop a member that does not use the glass fiber.

Meanwhile, as an industrial material of motor vehicle or weak electric current, there is known an injection-molded product obtained by mixing an inorganic material such as a glass fiber, talc, mica etc. into a polypropylene resin in order to enhance rigidity and heat resistance. In the case of fabricating a base material for the interior ceiling material of the automobile by means of this injection molding, a problem occurs that the weight of the base material is increased.

Therefore, the present inventors have examined a combination of a thin plastic sheet, which polypropylene resin and mica are kneaded and extruded without using the glass fiber, and foamed polypropylene. In the case of an extrusion-molded product formed of the kneaded resin of polypropylene and mica, there exists a problem on film formability of a targeted thin sheet having 300 μm or less.

In order to solve this problem, the present applicant has earlier proposed a base material for an automobile interior ceiling material, as a laminate formed of at least a foamed polypropylene sheet and a filler-containing polypropylene sheet laminated on both sides of the foamed polypropylene sheet (see Japanese Unexamined Patent Application Publication No. 2002-12093 or U.S. Pat. No. 6,655,730).

However, a more detailed examination has been made of a technical content of the automobile interior ceiling material proposed above, it has been turned out that there is a room for improvement with regard to the following.

In other words, for the earlier proposed technology, because the foamed polypropylene as a core material has a great shrinkage rate after being molded, a laminated member in which the filler-containing polypropylene sheet is attached to both sides of the foamed polypropylene sheet is used as the base material. The laminated member is preheated, cold-pressed and then molded in a shape conformed to the indoor surface of the automobile top plate. Thereby, the automobile interior ceiling material is obtained, but it has a great shrinkage error caused by cooling. Hence, there is a fear of causing an error of attachment to the indoor surface of the automobile top plate.

Therefore, it is necessary either to bore a hole for attachment to the indoor surface of the automobile top plate in previous consideration of the post-molding shrinkage rate of the foamed polypropylene sheet, or to perform preheating, cold-pressing, cooling for a predetermined time, and boring of the base material, so that there remains a room for improvement in the aspect of production efficiency.

In addition, the earlier proposed technology improves the film formability, rigidity, moldability, etc. required as a plastic laminated material, but it leaves a room for improvement with respect to dimensional stability and heat resistance of the product (the automobile interior ceiling material) after molded.

### SUMMARY OF THE INVENTION

The present invention has been made in view of such conventional circumstances. Accordingly, it is a first object of the present invention to obtain a base material for an automobile interior ceiling in which filler-containing resin sheets are laminated on both sides of a core material of a foamed resin in consideration of molding workability, environmental aspect, recycle capability and so forth, without using a glass fiber. Further, the present invention is to provide a novel laminated member having an improved post-molding dimensional error or heat resistance while still having advantages of good film formability, lightweight and high rigidity, excellent moldability, no problem of wrinkles, and the like, which can be obtained by the earlier proposed technology.

In order to accomplish these objects, a laminated member according to the present invention is characterized by comprising at least a foamed polyurethane sheet (1) and filler-containing polypropylene sheets (4 and 5) laminated on both sides of the foamed polyurethane sheet with adhesive layers (2 and 3) interposed therebetween.

In this manner, the foamed polyurethane sheet (1) as a core material is used in place of a conventional foamed polypropylene sheet. Thereby, it is possible to obtain a product which has good film formability, lightweight and high rigidity, excellent moldability on cold-pressing after preheating, no problem of wrinkles, improved shrinkage and heat resistance of a post-molding product (automobile interior ceiling material), and a small post-molding dimensional error.

In order to more securely obtain the respective characteristics, preferably, the foamed polyurethane sheet (1) is a sheet having a thickness of 2 to 20 mm which is formed of a semi-hard foamed polyurethane and has a foaming ratio of 15 to 40 times and a density of 0.067 to 0.025 g/cm³.

Further, the filler-containing polypropylene sheets (4 and 5), preferably, are sheets having a thickness of 100 to 300 μM which are formed of a polypropylene resin containing 15 to 40 wt % filler.

In the present invention, the filler contained in the polypropylene resin may include, for example, mica, talc, titan, calcium carbonate, barium sulfate, sodium silicate, calcium silicate, aluminum oxide, ceramic fiber, magnesium sulfate, zonolite, cellulose, woodchip, quartz, carbon black, metal powder, lignin, titanium white, titanium oxide, zinc oxide, whisker, aramid fiber, artificial wood, montmorillonite, hectolite, saponite, silicon carbide, aluminum nitride, cobalt oxide, etc.

Among them, the mica having a particle diameter of 10 to 700 μm is preferably used in order to accomplish the objects of the present invention.

Further, the polypropylene resin containing the filler, preferably, is one having a melt flow rate of 3 to 40 g/10 min. at a test temperature of 230° C. and a test load of 21.18 N.

A more preferable configuration of the laminated member according to the present invention is a laminate of a seven-layered structure comprising filler-containing polypropylene sheets (4 and 5) laminated on both sides of a foamed polyurethane sheet (1) with adhesive layers (2 and 3) interposed therebetween, and an adhesive layer (6) laminated to adhere an interior material (8) to one-sided filler-containing polypropylene sheet (4) and a backing material (7) adhered to the other-sided filler-containing polypropylene sheet (5).

Each of the adhesive layers (2, 3 and 6) is a hot melt material in the form of a sheet, a web or a powder, consisting of any one of low melting-point polyester, polyamide, polyolefin, polyurethane, ethylene vinyl acetate copolymer resin, and polyvinyl chloride resin. In the present invention, the hot melt material in a web is a hot melt material in the form of a web sheet having a plurality of openings in the form of a cobweb and a mesh.

Further, each of the adhesive layers (2, 3 and 6) may, preferably, use one having a weight per unit area of 7 to 100 g/m².

In the present invention, the backing material (7) refers to a material attached to prevent a rubbing sound accompanied with vibration while an automobile is traveling. The backing material, preferably, uses a non-woven fabric consisting essentially of polyester, and more preferably has a weight per unit area of 14 to 100 g/m².

The laminated member according to the present invention can obtain the automobile interior ceiling material as a product by forming a laminate of an eight-layered structure in which an interior material (8) is overlapped on an outer surface of the adhesive layer (6) facing the inside of an automobile, preheating the laminate of the seven-layered structure, and then molding the preheated laminate in a shape conformed to an indoor surface of an automobile top plate, or by preheating the laminate of the seven layered structure, immediately after that, overlapping an interior material (8) on an outer surface of an adhesive layer (6) facing the inside of an automobile, and cold-pressing and molding the overlapped laminate in a shape conformed to an indoor surface of an automobile top plate.

As the interior material 8 used in the present invention, for example, either a skin material having no air permeability, such as a formed polyethylene sheet, a vinyl chloride sheet, etc., or an interior material having air permeability such as a tricot material, to which a non-woven fabric and a polyurethane lining material are attached, may be used.

Since the laminated member according to the present invention has the configuration mentioned above, it is possible to obtain a product (automobile interior ceiling material) which has good film formability as a thin sheet, lightweight and sufficient rigidity, and excellent moldability on cold-pressing after preheating, no problem of wrinkles, improved shrinkage and heat resistance of a post-molding product (automobile interior ceiling material), and a small post-molding dimensional error.

### BRIEF DESCRIPTION OF THE DRAWINGS

FIG. 1 is an enlarged longitudinal cross-section view showing an example of a laminated member according to an embodiment of the present invention.

### DESCRIPTION OF THE PREFERRED EMBODIMENTS

Hereinafter, an example of an embodiment of a laminated member according to an embodiment of the present invention will be described with reference to the drawing.

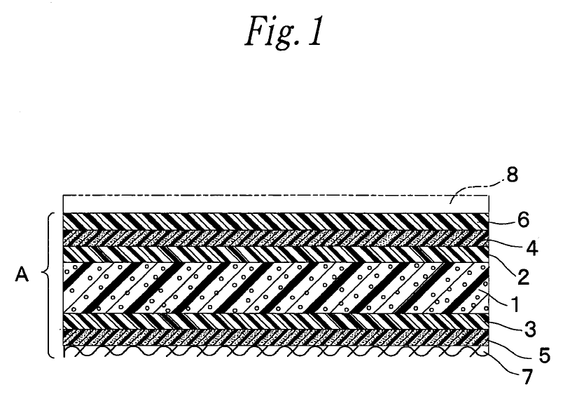

The laminated member A shown FIG. 1 is a laminate of a seven-layered structure, which is formed by overlapping a hot melt film of low melting-point polyester formed into adhesive layers 2 and 3 on both sides of a foamed polyurethane sheet 1, and further laminating mica-containing polypropylene sheets 4 and 5 on outer surfaces of the hot melt film, and by laminating a hot melt film of low melting-point polyester formed into an adhesive layer 6 for adhering an interior material 8 in future on an outer surface of the one-sided mica-containing polypropylene sheet 4 and by adhering a backing material 7 formed of a non-woven fabric consisting essentially of polyester on an outer surface of the other-sided mica-containing polypropylene sheet 5.

As the foamed polyurethane sheet, there are a hard foam, a semi-hard foam and a soft foam, in which the hard foam is too rigid to generate a crack on molding, and the soft foam is deteriorated in rigidity as an automobile interior ceiling material. Therefore, in terms of the formed polyurethane sheet, in the present invention, the semi-hard foam is employed in consideration of the balance of rigidity and lighter weight, which is set to a foaming ratio of 15 to 40 times, a density of 0.067 to 0.025 g/cm³, and a thickness of 2 to 20 mm.

The mica-containing polypropylene sheets 4 and 5 are sheets having a thickness of 100 to 300 μm, which contain 15 to 40 wt % mica having a particle diameter of 10 to 700 μm in the polypropylene resin having a melt flow rate of 3 to 40 g/10 min. at a test temperature of 230° C. and a test load of 21.78 N.

The laminated member for the automobile interior ceiling material according to the present invention generally determines its laminated structure based on required rigidity, stretchability and lightweight characteristic.

In the present invention, the foamed polyurethane sheet having a thickness of 2 to 20 mm is adopted as a core material, and the hot melt film (adhesive layer) 6 of low melting-point polyester, the mica-containing polypropylene sheet 4, the hot melt film (adhesive layer) 2 of low melt-melting polyester, the foamed polyurethane sheet 1, the hot melt film (adhesive layer) 3 of low melting-point polyester, the mica-containing polypropylene sheet 5 and the backing material 7 are laminated in that order to form the seven layered structure, which is adopted as the laminate having characteristics required as the automobile interior ceiling material.

The thickness of the laminate is determined by the goals of its rigidity and lighter weight. Usually, in the case of the laminated member A of the seven-layered structure, its thickness is dependent on the thickness of the foamed polyurethane sheet 1 serving as the core material, and is set to about 2 to 20 mm. When this thickness is less than 2 mm, it is difficult to maintain rigidity. Even when the thickness exceeds 20 mm, it is impossible to expect remarkable improvement in property.

Since the laminated member A according to the present example is the base material of the automobile interior ceiling material, it generally becomes a laminate of an eight layered structure having an interior material 8 attached to the outermost layer of the surface side (indoor side of an automobile ceiling) in order to maintain a beauty in the state of the laminated member A or in the process of molding the automobile interior ceiling material from the laminated member A. As the interior material 8, it is preferred that a non-woven fabric, tricot skin, leather, artificial leather or so forth is used.

The backing material 7 is attached to the outermost layer of the laminated member A on its rear side (on the surface side attached to the automobile ceiling) so as to prevent a rubbing sound accompanied with vibration, as set forth above. As the backing material 7, non-woven fabrics obtained by various manufacturing methods, etc. are mainly employed, but it is preferable to use the non-woven fabric consisting essentially of polyester, and it is more preferable to use the non-woven fabric having a weight per unit area of 14 to 100 g/m².

Further, an auxiliary layer other than the backing material 7 and the interior material 8 may be added for the purpose of compensating a shortage of strength, etc.

The laminated member A obtained in this manner, as mentioned above, has the interior material 8 attached to the surface facing the automobile indoor side with the hot melt material (adhesive layer) 6. The adhesion of the interior material 8 is efficient to be simultaneously performed when the laminated member A is molded into the automobile interior ceiling material.

In other words, the laminated member A of the seven-layered structure is first placed in a heating furnace without the interior material 8, and preheated until the surface temperature of the holt melt material 6 on the side attaching the interior material 8 reaches 170° C. or more. Immediately after that, the laminated member is transferred to a cooling mold, covered and pressed with the interior material 8 at the same time, pressure-molded for a time of about 30 to 50 seconds to be molded in a shape conformed to an indoor surface of an automobile top plate. Thereby, it is possible to obtain the automobile interior ceiling material of a desired shape.

Alternately, in the laminated member A of the seven-layered structure without the interior material 8, an eight-layered structure may be formed by overlapping the interior material 8 on the outer surface of the holt melt material 6 on the side attaching the interior material 8. The laminated member A of the eight-layered structure may be preheated until a surface temperature of the holt melt material 6 reaches 170° C. or more. Immediately after that, the laminated member may be transferred to a cooling mold, pressure-molded for a time of about 30 to 50 seconds to be molded in a shape conformed to an indoor surface of an automobile top plate. Thereby, it is possible to obtain the automobile interior ceiling material of a desired shape.

Hereinafter, description will be made of more concrete example and comparative example.

### EXAMPLE 1

A foamed polyurethane sheet having a thickness of 7 mm and a weight of 240 g/m² was adopted as a core material. A mica-containing polypropylene sheet having a thickness of 250 μm was laminated on both sides of the foamed polyurethane sheet with a hot melt film of low melting-point polyester having a weight of 35 g/m² interposed therebetween. A backing material having a weight of 14 g/m² and formed of a non-woven fabric at the outermost layer of an automobile ceiling side was laminated. As a result, a laminated member of a seven-layered structure was obtained. For the laminated member, a measure was made of a post-molding shrinkage rate and heat resistance (heat-resistant strain) by means of the following method.

(Post-Molding Shrinkage Rate)

The laminated member was cut off in the size of 250 mm×250 mm. The cut laminated member was put in an oven for preheating, heated for about 40 seconds until its surface temperature reached 170° C. or more, discharged from the oven, put in a cooling mold where upper and lower molds were flat, and pressed for about 30 seconds. Thereby, a sample was obtained.

The upper and lower cooling molds were provided with protrusions at two places at a spaced dimension of 200 mm. Marks (recesses) caused by the protrusions were formed at two places on the surface of the sample pressed in the cooling mold. The shrinkage rate of the sample was calculated on the basis of the position of the protrusions provided in the mold by measuring changes in the position of the marks at the two places in widthwise and longitudinal directions of the sample at every predetermined time from immediately after pressing was performed. The results are given in Table 1.

(Heat Resistance) A jig was set, which has posts stood on a base at a spaced dimension of 245 mm at left and right two places in the preheating oven where an internal temperature was set to 100° C. A sample obtained by cutting off the laminated member at a width of 100 mm and a length of 380 mm was put across the posts to be equally positioned left and right. Furthermore, a weight formed of a square bar having a length of 100 mm and a weight of 100 g was put at a longitudinal middle position (middle position between the left and right posts) along the widthwise direction of the sample. In that state, the dimension of height H from the middle position of the sample at which the weight was put to the base of the jig was measured and set to a reference value H₁.

Then, after the temperature in the oven was increased up to 100° C., the sample was left as it was. After one hour had lapsed, the height dimension H was measured, and compared with the reference value. The results are given in Table 2.

### COMPARATIVE EXAMPLE 1

A foamed polyurethane sheet having a thickness of 4 mm and a weight of 245 g/m²was adopted as a core material. A mica-containing polypropylene sheet having a thickness of 250 μm was laminated on both sides of the foamed polyurethane sheet. A backing material having a weight of 14 g/m² and formed of a non-woven fabric at the outermost layer of an automobile ceiling side was laminated. As a result, a laminated member of a four-layered structure was obtained. For the laminated member, a measure was made of a post-molding shrinkage rate and heat resistance (heat-resistant strain) by means of the same method as the Example 1. The results are given in Tables 1 and 2.

TABLE 1

| | | Imme- | | | | |
|---|---|---|---|---|---|---|
| | | diately | After | | After | After |
| | Measuring | after | 10 | After 1 | 24 | 48 |
| Sample | Direction | molded | minutes | hour | hours | hours |
| Example 1 | Widthwise | 0.27% | 0.37% | 0.39% | 0.40% | 0.40% |
| | Lengthwise | 0.25% | 0.35% | 0.37% | 0.39% | 0.39% |
| Compar- | Widthwise | 0.52% | 0.56% | 0.62% | 0.68% | 0.69% |
| ative | Lengthwise | 0.52% | 0.57% | 0.61% | 0.68% | 0.69% |
| Example 1 | | | | | | |

TABLE 2

| Sample | After 1 hour at 100° C. |
|---|---|
| Example 1 | 2.5 to 3 mm |
| Comparative example 1 | 4.5 to 6 mm |

It could be seen from the above results that, in the laminated member for an automobile interior ceiling material according to the present invention having at least a seven-layered structure, formed by laminating filler-containing polypropylene sheets on both sides of a foamed polyurethane sheet with adhesive layers interposed therebetween, and by laminating an adhesive layer for adhering an interior material on the one-sided filler-containing polypropylene sheet and by laminating a backing material on the other-sided filler-containing polypropylene sheet, the shrinkage rate and the heat resistance after molded were predominant.

What is claimed is:

1. A laminated member for an automobile interior ceiling material, having at least a seven-layered structure comprising: filler-containing polypropylene sheets (4 and 5) laminated on both sides of a foamed polyurethane sheet (1) with adhesive layers (2 and 3) interposed therebetween; an adhesive layer (6) laminated to adhere an interior material (8) to one-sided filler-containing polypropylene sheet (4); and a backing material (7) laminated on the other-sided filler-containing polypropylene sheet (5).

2. A laminated member according to claim 1, wherein the foamed polyurethane sheet (1) includes a sheet, having a thickness of 2 to 20 mm, which is formed of a semi-hard foamed polyurethane and has a foaming ratio of 15 to 40 times and a density of 0.067 to 0.025 g/cm³.

3. A laminated member according to claim 1, wherein an eight-layered structure is formed by overlapping an additional interior material (8) on an outer surface of the adhesive layer (6).

4. An automobile interior ceiling material formed by molding the laminated member according to claim 1 in a shape conformed to an indoor surface of an automobile top plate.
